(19) United States
(12) Patent Application Publication
(10) Pub. No.: US 2004/0022981 A1
(43) Pub. Date: Feb. 5, 2004

(54) Composite of single-wall carbon nanotubes and aromatic polyamide and process for making the same

(75) Inventors: Xiaodong Hu, Houston, TX (US); Kenneth A. Smith, Houston, TX (US)

Correspondence Address: Kenneth D. Goodman, Williams, Morgan & Amerson, P.C., Suite 1100, 10333 Richmond, Houston, TX, 77042, US

(73) Assignee: CARBON NANOTECHNOLOGIES, INC.

(21) Appl. No.: 10/403,517

(22) Filed: Mar. 31, 2003

Related U.S. Application Data
(60) Provisional application No. 60/369,126, filed on Apr. 1, 2002.

(51) Int. Cl. B32B 1/08

(52) U.S. Cl. 428/36.9; 428/408

(57) ABSTRACT

A composite comprising single-wall carbon nanotubes and aromatic polyamide, can be made by suspending single-wall carbon nanotubes in an acid to form a nanotube-acid mixture, adding an aromatic polyamide to the nanotube-acid mixture and dispersing the single-wall carbon nanotubes in the polyamide to form a single-wall carbon nanotube-polyamide dope. The dope can be spun into a fiber or formed into a film. Acid can be removed from the composite. A preferred polyamide is poly(p-phenylene terephthalamide). Carbon nanotube-aromatic polyamide composites can be used in applications requiring material having high tensile strength and modulus, such as, structural reinforcement materials, protective elements in ballistic protection applications wherein the composite material absorbs impact energy of projectiles, fragments, or other energetic particles. Ballistic protection applications include armor for personnel, structures and vehicles.

### CROSS-REFERENCE TO RELATED APPLICATION

This application claims priority from U.S. provisional application Serial No. 60/369,126, filed Apr. 1, 2002, which application is incorporated herein by reference.

### FIELD OF THE INVENTION

This invention relates generally to single-wall carbon nanotubes, and more particularly to a composite of single-wall carbon nanotubes and aromatic polyamide and method for making the same.

### BACKGROUND OF THE INVENTION

Single-wall carbon nanotubes (SWNT), commonly known as “buckytubes,” have unique properties, including high strength, stiffness, thermal and electrical conductivity. SWNT are hollow, tubular fullerene molecules consisting essentially of sp²-hybridized carbon atoms typically arranged in hexagons and pentagons. Single-wall carbon nanotubes typically have diameters in the range of about 0.5 nanometers (nm) and about 3.5 nm, and lengths usually greater than about 50 nm. Background information on single-wall carbon nanotubes can be found in B. I. Yakobson and R. E. Smalley, American Scientist, Vol. 85, July-August, 1997, pp. 324-337 and Dresselhaus, et al., Science of Fullerenes and Carbon Nanotubes, 1996, San Diego: Academic Press, Ch. 19.

The tensile strength and modulus of single-wall carbon nanotubes have been estimated to be as high as 100 and 1000 GPa, respectively. (See J-P. Salvetat-Delmotte and A. Rubio, Carbon, Vol. 40, 2002, pp. 1729-1734.) The strength and modulus of single-wall carbon nanotubes, combined with their large aspect ratios, render them potentially useful as reinforcing material for fabrication in advanced composites. Additionally, single wall carbon nanotubes are electrically and thermally conductive. Incorporating them into a matrix material could not only reinforce a matrix material, but also makes it electrically and thermally conductive.

However, the ability to realize the full strength and conductivity potential of single-wall carbon nanotubes in composite matrices, such as polymers, has been hampered by difficulties in dispersing the nanotubes in composite matrices. The problems associated with dispersing single-wall carbon nanotubes are due largely to their insolubility in polymers and most common solvents, and their propensity to rope together in SWNT bundles and be held tightly together by van der Waals forces. Generally, when attempts have been made to uniformly disperse single-wall carbon nanotubes in polymers, the concentrations of single-wall carbon nanotubes have typically been low, e.g. less than about 1 wt % of the polymer. Attempts to disperse single-wall carbon nanotubes in a composite matrix either through sidewall functionalization or end-group derivatization can significantly alter the properties of the nanotubes. For example, the electrical conductivity of the nanotubes can be decreased by adding functional groups to nanotubes, and, in some instances, the nanotube structure can be damaged or the nanotube shortened in derivatization procedures. To better realize the nanotubes' mechanical and electronic properties, a method is needed for preparing an advanced composite comprising well-dispersed, underivatized single-wall carbon nanotubes that can be shaped into fibers, films or other composite forms.

### SUMMARY OF THE INVENTION

The present invention relates to a composite comprising single-wall carbon nanotubes and aromatic polyamide, and method for making the same. In one embodiment, a composite comprising single-wall carbon nanotubes and aromatic polyamide can be made by the steps comprising, suspending single-wall carbon nanotubes in an acid to form a nanotube-acid mixture, adding an aromatic polyamide to the nanotube-acid mixture, dispersing the single-wall carbon nanotubes in the polyamide to form a single-wall carbon nanotube-polyamide dope, and removing the acid to form a nanotube-polyamide composite. In one embodiment of the invention, the composite is a fiber. In another embodiment, the composite is prepared by mixing single-wall carbon nanotubes with aromatic polyamide in an acid media to form a single-wall carbon nanotube-polyamide dope. In yet another embodiment, the dope is spun into a fiber and the acid removed. In yet another embodiment, the dope is formed into a film and the acid removed. In one embodiment the aromatic polyamide is poly(p-phenylene terephthalamide).

The composite of this invention is particularly useful in films or fibers requiring high tensile strength and modulus. Films and a plurality of fibers are useful in applications, such as, but not limited to, structural reinforcement materials, protective elements in ballistic protection applications wherein the composite material absorbs impact energy of projectiles, fragments, or other energetic particles. Ballistic protection applications include armor for personnel, structures and vehicles.

### DETAILED DESCRIPTION OF SPECIFIC EMBODIMENTS

The present invention relates to a composite comprising single-wall carbon nanotubes and aromatic polyamide, and method for making the same. In one embodiment, a composite comprising single-wall carbon nanotubes and aromatic polyamide can be made by the steps comprising, suspending single-wall carbon nanotubes in an acid to form a nanotube-acid mixture, adding an aromatic polyamide to the nanotube-acid mixture, dispersing the single-wall carbon nanotubes in the polyamide to form a single-wall carbon nanotube-polyamide dope, and removing the acid to form a nanotube-polyamide composite. In one embodiment of the invention, the composite is a fiber. In another embodiment, the composite is prepared by mixing single-wall carbon nanotubes with aromatic polyamide in an acid media to form a single-wall carbon nanotube-polyamide dope. In yet another embodiment, the dope is spun into a fiber and the acid removed. In yet another embodiment, the dope is formed into a film and the acid removed. In one embodiment the aromatic polyamide is poly(p-phenylene terephthalamide).

The single-wall carbon nanotubes can be made by any known means. The carbon nanotubes are preferably purified. Purification of the nanotube material can be done to remove amorphous carbon, metallic impurities and non-nanotube carbon. For certain applications, purification may be preferred and can be done by any known means. Suitable procedures for purification of carbon nanotubes are related in International Patent Publications “Process for Purifying Single-Wall Carbon Nanotubes and Compositions Thereof,” WO 02/064,869 published Aug. 22, 2002, and “Gas Phase Process for Purifying Single-Wall Carbon Nanotubes and Compositions Thereof,” WO 02/064,868 published Aug. 22, 2002, and included herein in their entirety by reference.

To make a dispersible mixture of single-wall carbon nanotubes, the purified nanotubes can, optionally, be dried under mild conditions. In one embodiment, the nanotubes are dried in a vacuum oven at 80° C. overnight. To make a slurry of nanotubes, the nanotubes are mixed with anhydrous 100% sulfuric acid or a superacid. Examples of superacids include, but are not limited to, Bronsted superacids, Lewis superacids, and conjugate Bronsted-Lewis superacids. The superacids can be in a melt, liquid or gaseous form. Bronsted superacids are those whose acidity exceeds that of 100% sulfuric acid. Examples of Bronsted superacids include perchloric acid (HClO₄), chlorosulfuric acid (ClSO₃H), fluorosulfuric acid (HSO₃F), chlorosulfonic acid, fluorosulfonic acid, and perfluoroalkanesulfonic acids, such as trifluoromethanesulfonic acid (CF₃SO₃H), also known as triflic acid, and higher perfluoroalkanesulfonic acids, such as C₂F₅SO₃H, C₄F₉SO₃H, C₅F₁₁ SO₃H, C₆F₁₃SO₃H, C₈F₁₇SO₃H,

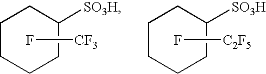

and α,ω-perfluoroalkanedisulfonic acids. Lewis superacids have been defined by Olah, et al. (See “Superacids” John Wiley & Sons, 1985) as those acids stronger than anhydrous aluminum chloride. Lewis superacids include antimony pentafluoride, arsenic pentafluoride, tantalum pentafluoride and niobium pentafluoride. Antimony pentafluoride and arsenic pentafluoride form stable intercalation compounds with graphite. Conjugate Bronsted-Lewis superacids include SO₃-containing sulfuric acids, also known as oleums or polysulfuric acids, polyphosphoric acid-oleum mixtures, tetra(hydrogen sulfato)boric acid-sulfuric acid, fluorosulfuric acid-antimony pentafluoride (also known as “magic acid”), fluorosulfuric acid-sulfur trioxide, fluorosulfuric acid-arsenic pentafluoride, HSO₃F:HF:SbF₅, HSO₃F:SbF₅:SO₃, perfluoroalkanesulfonic acid-based systems, such as CₙF₂ₙ₊₁SO₃H:SbF₅, where n=1, 2 or 4, and CF₃SO₃H:B(SO₃CF₃)₃, hydrogen-fluoride-antimony pentafluoride (also known as fluoroantimonic acid), hydrogen fluoride-tantalum pentafluoride, hydrogen fluoride-boron trifluoride (also known as tetrafluoroboric acid), and conjugate Friedel-Crafts acids, such as HBr:AlBr₃, and HCl:AlCl₃. For description and clarity, anhydrous 100% sulfuric acid or oleum (H₂SO₄ with added SO₃), also known as fuming sulfuric acid, will be used as exemplary acids.

In one embodiment, the nanotubes are mixed with anhydrous 100% sulfuric acid or superacid to produce a high level of dispersion of single wall carbon nanotubes in the acid. Mixing is done by any suitable mixing means. Examples of suitable mixing methods include, but are not limited to, blending in a blender, sonicating, mechanical stirring, and combinations thereof. To prevent the uptake of moisture and oxygen from the atmosphere, the mixing is done in a glove or purge box under a moisture-free, oxygen-free inert atmosphere, such as under nitrogen, argon, an inert gas or combinations thereof. Mixing is done for a length of time needed to make a uniform suspension of the nanotubes. A typical mixing time is on the order of about a half hour, but can vary depending on, but not limited to, the amount of nanotubes, the temperature, the acid used and the mixing means used. After mixing, the nanotube-acid mixture is kept under nitrogen or an inert atmosphere. Moisture absorption will reduce the concentration of the acid and can result in inhomogeneity of the dope.

After the nanotube-acid mixture is prepared, the aromatic polyamide, also known as polyaramid, is combined with the nanotube-acid mixture. Examples of aromatic polyamides include, but are not limited to, polyphenylene terephthalamides. For clarity and conciseness, poly(p-phenylene terephthalamide) (“PPTA”) will be used as an exemplary aromatic polyamide.

In one embodiment, the aromatic polyamide is dried to remove moisture. Suitable conditions for drying the polymer include, but are not limited to, vacuum drying at 80° C. overnight. Preferably, the drying is done for at least 8 hours.

The aromatic polyamide is then added to nanotube-acid suspension. The polymer and the nanotube-acid mixture are then mixed by any suitable mixing means. Examples of mixing means are, but not limited to, blending in a blender, sonication, mechanical stirring, and combinations thereof. The mixing is done for a time needed to make a generally homogeneous mixture. In one embodiment, mixing can be done in about a half hour. The mixing time will depend on, but not limited to, the temperature, mixing means, amount of nanotubes in the acid and the amount of polymer. Mixing is preferably done under nitrogen or an inert gas atmosphere, such as argon.

Further dispersion of the nanotubes is done by intensive blending, such as, but not limited to, a twin-blade mixer. The blending time can vary depending on, but not limited to, the amount of nanotubes in the acid, the type of acid, the type and amount polymer and the polymer viscosity or molecular weight. In one embodiment, the blending can be done in about three hours. The resulting nanotube-acid-polymer mixture is referred to as “dope,” and is generally uniform and optically anisotropic under as viewed by optical microscopy using polarized light.

In one embodiment, the dope is spun into a fiber. Transfer of the dope to the chamber of the spinning equipment is done under nitrogen or an inert environment, such as argon. The chamber for the dope is generally heated. The chamber temperature will depend on, but not limited to, the type and molecular weight of the polymer, the concentration of nanotubes, and the amount of acid in the dope. In one embodiment, the chamber temperature is heated in the range of about 20° C. and about 110° C. The dope is maintained at temperature under pressure for some time before spinning. Generally, the dope will be maintained at temperature and under pressure for at least about an hour.

Fiber spinning may be done by any suitable technique. One such method is dry-jet wet spinning using a piston driven spinning system. For fiber spinning, the polymer solution or dope comprising the nanotubes, acid and polymer, preferably is maintained between about 100° C. and about 150° C. An air gap preferably is maintained in the range of about 2 cm and about 25 cm. Extruded fiber is coagulated in water at room temperature. Fiber is washed in running water for about a week or for any time sufficient to remove the acid from the fiber. The fiber is subsequently dried in vacuum at about 80° C. Dried fiber can be heat-treated in nitrogen at about 400° C. to impart higher strength and tensile properties.

The diameter of the spinneret lumen is generally in the range of about 60 microns and about 300 microns. The dope is preferably filtered prior to passing through the spinneret, such as through a 50-micron screen, in order to filter any large particles before entering the spinneret. After passing through the spinneret, the fiber enters an aqueous bath used to coagulate the fiber. The bath temperature may be in a range of temperatures, such as between about 5° C. and about 20° C. Prior to coagulation, the dope emerging from the spinneret goes through an air gap. The air gap distance can be varied. Generally, the air gap is in the range of about 2.0 and about 20 cm. The collected fiber is can be immersed in running water for a few days in order to remove the acid from the fiber. After washing, the composite fiber can be air-dried. This air-dried fiber is known as an “as-spun” fiber. The “as-spun” fiber can also be heat treated.

To heat-treat the fibers, the “as-spun” fibers are heated in a tubular oven under a nitrogen atmosphere. The oven temperatures are in generally in the range of about 300° C. and about 500° C. Preferably, the fiber is under tension during heat treatment. The duration of heat treating is generally at least about 10 seconds.

One embodiment of this invention combines aromatic polyamide and single-wall carbon nanotubes in a mutually compatible strong acid, such as anhydrous 100% sulfuric acid. This choice of compatible elements enables a composition of a “spin-dope” comprising substantial concentration of single-wall carbon nanotubes in aromatic polyamide. In the examples, an exemplary aromatic polyamide, poly(p-phenylene-terephthalamide) (“PPTA”), is used. Other suitable aromatic polyamides are described in U.S. Pat. No. 3,671,542, entitled “Optically Anisotropic Aromatic Polyamide Dopes” (1972).

In one embodiment of the present invention, the nanotube-aromatic polyamide composite comprises at least about 1 wt % single-wall carbon nanotubes. In another embodiment, at least about 10 wt % single-wall carbon nanotubes are present in the composite. In yet another embodiment of the invention, the aromatic polyamide comprises at least about 80 wt % of the composite. In another embodiment of the invention, the aromatic polyamide comprises at least about 90 wt % of the composite. In yet another embodiment, the aromatic polyamide is poly(p-phenylene terephthalamide), wherein the poly(p-phenylene terephthalamide) is present in the composite in an amount of at least about 80 wt % of the composite. In another embodiment, the poly(p-phenylene terephthalamide) is present in the composite in an amount of at least about 90 wt % of the composite. The form of the composite is generally that of a film or fiber, however other forms can be made from the composite.

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### EXAMPLE 1

This example demonstrates the preparation of a single-wall carbon nanotube-aromatic polyamide dope and spinning of the dope into a composite in the form of a fiber. 1.8 g single-wall carbon nanotubes and 80 g 100% sulfuric acid were mixed in a blender for 15 minutes under an inert argon gas purge. 16.2 g dried poly(p-phenylene terephthalamide) (PPTA) with an inherent viscosity of 5.86, as measured as a solution of 0.25 grams polymer in 50 ml of 95-98 wt % sulfuric acid, was then added to the blender. The mixture was blended for 20 minutes to form a “pre-mixed” paste. The “pre-mixed” paste was further mixed at 85° C. in a Haake Rheomix 600 twin-blade rolling mixer at 50 rpm for 3 hours until a uniform dope was obtained.

The spinning chamber was electrically heated to 90° C. The dope was transferred into the spinning chamber under a nitrogen purge and maintained at temperature for one hour. The dope was extruded from a 250-micron diameter spinneret into a water bath held at 5° C. The gap between the spinneret and the water bath was 25 mm. The as-spun fiber was put in running water for 5 days, after which it was air-dried for one day.

The diameter of the fiber was measured using an optical microscope. Tensile testing was performed on an Instron Universal Tensile Tester (Model 5567) at 2.54-cm gauge length at a strain rate of 2% per minute. The tensile strength and elastic modulus of the fiber was 0.33 GPa and 13 GPa, respectively.

### EXAMPLE 2

This example demonstrates the preparation of a single-wall carbon nanotube-aromatic polyamide dope, spinning of the dope into a composite in the form of a fiber, and the effect of heat-treating the fiber under tension. 0.6 g purified and dried single-wall carbon nanotubes and 23 g of 100.9 wt % sulfuric acid were added to a two-neck glass flask with a mechanical stirrer under an argon purge. The glass flask was partially immerged in an oil bath and the mixture was stirred for 1 hour. 5.4 g dried poly(p-phenylene terephthalamide) (PPTA) and 21 g 100.9 wt % sulfuric acid were added to the flask. The mixture was heated to 80° C. and maintained for 2.5 hours. A homogenous dope resulted. After cooling to room temperature, the dope was put into a fiber-spinning chamber.

The spinning chamber was heated to 80° C. and maintained at temperature for 2.5 hours. The spinning conditions were the same as in Example 1, except that a smaller 120-micron diameter spinneret was used.

The as-spun fiber was immersed in running water for 5 days, after which it was air-dried for one day. The fiber was stretched over 5% of its initial length and fixed in a metal frame. The frame with the stretched fiber was put in a tubular oven at 450° C. for 30 seconds under a nitrogen atmosphere to produce a heat-treated fiber.

Tensile testing was performed on an Instron Universal Tensile Tester (Model 5567) at 2.54-cm gauge length at a strain rate of 2% per minute. The tensile strength and tensile modulus of the as-spun and heat-treated fibers are given in Table 1.

TABLE 1

| Fiber | Tensile Strength, GPa | Tensile Modulus, GPa |
|---|---|---|
| As-spun | 0.35 | 19 |
| Heat-treated | 0.57 | 46 |

### EXAMPLE 3

This example demonstrates the preparation of a single-wall carbon nanotube-aromatic polyamide dope and spinning of the dope into a composite in the form of a fiber. The same procedures as Example 2 were used except that the component amounts were 0.3 g dried single-wall carbon nanotubes, 5.7 g dried poly(p-phenylene terephthalamide) (PPTA), and 44 g 100.9 wt % sulfuric acid.

The dope was spun into fibers. Heat treatment of the as-spun fibers was done under the same conditions as Example 2. Tensile testing was performed on an Instron Universal Tensile Tester (Model 5567) at 2.54-cm gauge length at a strain rate of 2% per minute. The tensile strength and tensile modulus of the as-spun and heat-treated fibers are given in Table 2.

TABLE 2

| Fiber | Tensile Strength, GPa | Tensile Modulus, GPa |
|---|---|---|
| As-spun | 0.34 | 17 |
| Heat-treated | 0.42 | 31 |

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and methods and in the steps or in the sequence of steps of the method described herein without departing from the concept, spirit and scope of the invention. More specifically, it will be apparent that certain agents which are chemically related may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. A method for producing a composite comprising single-wall carbon nanotubes and aromatic polyamide comprising:
a) suspending single-wall carbon nanotubes in an acid to form a nanotube-acid mixture;
b) adding an aromatic polyamide to the nanotube-acid mixture;
c) dispersing the single-wall carbon nanotubes in the polyamide to form a single-wall carbon nanotube-polyamide dope; and
d) removing the acid to form a nanotube-polyamide composite.

2. The method of claim 1 wherein the polyamide is poly(p-phenylene terephthalamide).

3. The method of claim 1 further comprising spinning the dope into a fiber.

4. The method of claim 1 further comprising forming the dope into a film.

5. The method of claim 1 wherein the acid is sulfuric acid and wherein the sulfuric acid has a concentration of at least about 100 wt %.

6. The method of claim 1 wherein the acid is a superacid.

7. The method of claim 1 wherein the acid is oleum.

8. The method of claim 1 wherein the acid is removed from the composite with water.

9. The method of claim 1 further comprising heat-treating the fiber under tension.

10. The method of claim 1 wherein the nanotubes are present in an amount of at least about 1 wt % of the composite.

11. The method of claim 1 wherein the nanotubes are present in an amount of at least about 10 wt % of the composite.

12. The method of claim 1 wherein the aromatic polyamide is present in an amount of at least about 80 wt % of the composite.

13. The method of claim 1 wherein the aromatic polyamide is present in an amount of at least about 90 wt % of the composite.

14. A composite material comprising single-wall carbon nanotubes and an aromatic polyamide.

15. The composite of claim 14 wherein the nanotubes are present in an amount of at least about 1 wt % of the composite.

16. The composite of claim 14 wherein the nanotubes are present in an amount of at least about 10 wt % of the composite.

17. The composite of claim 14 wherein the aromatic polyamide is poly(p-phenylene terephthalamide).

18. The composite of claim 17 wherein the poly(p-phenylene terephalamide) is at least about 80 wt % of the composite.

19. The composite of claim 17 wherein the poly(p-phenylene terephalamide) is at least about 90 wt % of the composite.

20. A composite material comprising single-wall carbon nanotubes and poly(p-phenylene terephthalamide).

21. The composite of claim 20 wherein the nanotubes are present in an amount of at least about 1 wt % of the composite.

22. The composite of claim 20 wherein the nanotubes are present in an amount of at least about 10 wt % of the composite.

23. The composite of claim 20 wherein the poly(p-phenylene terephthalamide) is at least about 80 wt % of the composite.

24. The composite of claim 20 wherein the poly(p-phenylene terephthalamide) is at least about 90 wt % of the composite.

25. A single-filament fiber comprising a single-wall carbon nanotubes and poly(p-phenylene terephthalamide).

26. The fiber of claim 25 wherein the single-wall carbon nanotubes are present in an amount of at least about 1 wt % of the fiber.

27. The fiber of claim 25 wherein the single-wall carbon nanotubes is present in an amount of at least about 10 wt % of the fiber.

28. The fiber of claim 25 wherein the poly(p-phenylene terephthalamide) is at least about 80 wt % of the fiber.

29. The fiber of claim 25 wherein the poly(p-phenylene terephthalamide) is at least about 90 wt % of the fiber.

30. An armor comprising a plurality of fibers comprising single-wall carbon nanotubes and poly(p-phenylene terephthalamide).

31. The armor of claim 30 wherein the armor is body armor.

32. The armor of claim 30 wherein the armor is vehicle armor.
